(19) United States
(12) Patent Application Publication
(10) Pub. No.: US 2025/0058636 A1
(43) Pub. Date: Feb. 20, 2025

(54) METHOD OF PREDICTIVELY SMART CHARGING A VEHICLE INCLUDING CUSTOMER NOTIFICATIONS VIA WIRELESS TECHNOLOGIES AND VEHICLE INCLUDING THE SAME

(71) Applicant: GM GLOBAL TECHNOLOGY OPERATIONS LLC, Detroit, MI (US)

(72) Inventors: Matthew E. Gilbert-Eyres, Rochester Hills, MI (US); Benjamin Tran, Royal Oak, MI (US); Kevin W. Owens, Sterling Heights, MI (US); James Doherty, Canton, MI (US)

(73) Assignee: GM GLOBAL TECHNOLOGY OPERATIONS LLC, Detroit, MI (US)

(21) Appl. No.: 18/449,627

(22) Filed: Aug. 14, 2023

(51) Int. Cl. B60L 3/00

(52) U.S. Cl. CPC B60L 3/0046; G06Q 30/0283; G06Q 50/06

(57) ABSTRACT

A method of predictively charging a vehicle including a rechargeable energy storage system (RESS) includes providing a telematics system including a telematics module, at least one external data source, a utility data source, and at least one user interface. The telematics system receives weather forecast data from the at least one external data source; monitors the weather forecast data for a predicted weather event; compares the predicted weather event to historical weather events during which power disruptions occurred; determines whether the predicted weather event is indicative of a potential power disruption based upon the comparison; generates a power status report via the telematics system based upon a determination that the predicted weather event may be indicative of the potential power disruption; sends the power status report to the at least one user interface; and commands a charging of the vehicle based on the power status report.

### INTRODUCTION

The concepts described herein relate generally vehicles including rechargeable energy storage systems (RESS), and a method of predictively charging a vehicle including a RESS, which is configured to predictively charge the vehicle to a maximum possible charge prior to a potential power disruption based on a predicted weather event, such that the electric power stored within the vehicle may be utilized to power infrastructure, for example but not limited to, a furnace to heat a home, for a maximum amount of time during a power disruption or outage.

Each RESS includes a plurality of battery cell groups or packs, with each battery cell group including a plurality of battery cells, for example, lithium-ion battery cells.

A lithium-ion battery cell is an electrochemical device that operates by passing lithium ions between a negative electrode (or anode) and a positive electrode (or cathode). Electrochemical battery cells including, but not limited to, prismatic battery cells and cylindrical battery cells having metallic enclosures or “cans” may include heat dissipation pathways for effective and consistent heat dissipation over a life of the battery cell.

Direct-Current (DC) power sources, such as lithium-ion batteries, may be employed to store and release electric power that may be employed by an electric circuit or an electric machine to perform work, for example, releasing electric power stored in a vehicle to support powering a household or specific household items within a household during a power disruption or outage.

However, which specific household items could be powered, and the duration for which these specific household items may be powered depends on the amount of electric power stored within the vehicle including the RESS when the power disruption or outage occurs.

### SUMMARY

In view of the above discussion, it is useful to develop a method of predictively charging a vehicle including a rechargeable energy storage system (RESS), which is configured to predictively charge the vehicle to a maximum possible charge prior to a potential power disruption based on a predicted weather event. The electric power stored within the vehicle may be utilized to power infrastructure, for example but not limited to, a furnace to heat a home, for a maximum amount of time during a power disruption or outage.

Accordingly, a method of predictively charging a vehicle including a RESS is disclosed. The method may include providing a telematics system including a telematics module, at least one external data source, a utility data source, and at least one user interface. The telematics module may be disposed in a vehicle and may be in communication with the at least one external data source, the utility data source, the at least one user interface, and the vehicle.

The telematics system may receive weather forecast data from the at least one external data source; may monitor, via the telematics module, the weather forecast data for a predicted weather event; may compare the predicted weather event to historical weather events during which power disruptions occurred as indicated by historical utility data corresponding to the historical weather events; may determine whether the predicted weather event is indicative of a potential power disruption based upon the comparison; may generate a power status report based upon a determination that the predicted weather event may be indicative of the potential power disruption; may send the power status report to the at least one user interface; and may command a charging of the vehicle based on the power status report in preparation for the potential power disruption indicated by the predicted weather event.

Generating the power status report may include analyzing an amount of energy stored in the vehicle; analyzing historical houschold power consumption based on historical household power consumption data from the utility data source; analyzing predicted conditions of the predicted weather events; and analyzing costs to charge the vehicle.

Generating the power status report may include generating a charge strategy to charge the vehicle to a maximum charge possible before the potential power disruption while minimizing charging costs. The charge strategy may be based on a predictive algorithm.

Charging the vehicle according to the charge strategy may start automatically when an auto-charge is enabled, or may start based upon a user input to the at least one user interface when the auto-charge is not enabled.

Monitoring the weather forecast data for updates may occur when charging the vehicle starts.

The telematics system may command a connecting of the vehicle to a power station when the vehicle is charging and may command an automatic disconnecting of the vehicle from the power station when one of the updates to the weather forecast data includes a lightning strike within a predetermined distance of the vehicle.

The telematics system may monitor the weather forecast data after the lightning strike and automatically reconnect the vehicle to the power station after a predetermined time has elapsed without a subsequent lightning strike.

The telematics system may automatically alert a user, via the at least one user interface, when the lightning strike is within the predetermined distance of the vehicle.

Commanding the charging of the vehicle based upon the power status report may include sending the power status report to the at least one user interface.

The at least one user interface may include an human-machine interface (HMI) within the vehicle and/or a mobile application installed on a personal user device, for example but not limited to, a smart phone or tablet.

A method of predictively charging a vehicle including a rechargeable energy storage system (RESS) may include providing a power station that is connectable to a vehicle including a RESS; providing a telematics system including a telematics module, at least one external data source, a utility data source, and at least one user interface. The telematics module may be disposed in the vehicle and may be in communication with the at least one external data source, the utility data source, the at least one user interface, and the vehicle.

The telematics system may receive weather forecast data from the at least one external data source; may monitor the weather forecast data for a predicted weather event; compare the predicted weather event to historical weather events during which power disruptions occurred as indicated by historical utility data corresponding to the historical weather events; may determine whether the predicted weather event may be indicative of a potential power disruption based upon the comparison; and may generate a power status report.

The power status report may be generated based upon a determination that the predicted weather event is indicative of the potential power disruption.

Generating the power status report via the telematics system may include analyzing amount of energy stored in the vehicle; analyzing historical household power consumption based on historical household power consumption data from the utility data source; analyzing predicted conditions of the predicted weather events; and analyzing costs to charge the vehicle.

The telematics system may be configured to send the power status report to the at least one user interface.

Commanding a charging of the vehicle may be based on the power status report in preparation for the potential power disruption indicated by the predicted weather event when the vehicle is connected to the power station.

The telematics system may be configured to commanding a disconnecting of the vehicle from the power station when one of the updates to the weather forecast data may include a lightning strike within a predetermined distance of the vehicle.

Generating the power status report may include generating a charge strategy to charge the vehicle to a maximum charge possible before the potential power disruption while minimizing charging costs. The charge strategy may be based on a predictive algorithm.

Charging the vehicle according to the charge strategy may start automatically, when an auto-charge is enabled, or may start based upon a user input to the at least one user interface, when the auto-charge is not enabled.

A telematics system for predictively charging of a vehicle including a rechargeable energy storage system (RESS) is also disclosed. The telematics system may include a telematics module disposed in the vehicle, and at least one user interface.

The telematics module may be in communication with at least one external data source, a utility data source, the at least one user interface, and the vehicle.

The telematics system may be configured to receive weather forecast data from the at least one external data source, monitor the weather forecast data for a predicted weather event, compare the predicted weather event to historical weather events during which power disruptions occurred as indicated by historical utility data corresponding to the historical weather events, determine whether the predicted weather event is indicative of a potential power disruption based upon the comparison, and generate a power status report.

The power status report may be generated based upon determining that the predicted weather event is indicative of the potential power disruption.

Generating the power status report may include analyzing amount of energy stored in the vehicle, analyzing historical household power consumption based on historical household power consumption data from the utility data source, analyzing predicted conditions of the predicted weather events, and analyzing costs to charge the vehicle.

The telematics system may be configured to send the power status report to the at least one user interface, and command a charging of the vehicle based on the power status report in preparation for the potential power disruption indicated by the predicted weather event.

The power status report may include a charge strategy to charge the vehicle to a maximum charge possible before the potential power disruption while minimizing charging costs. The charge strategy may be based on a predictive algorithm.

The telematics system may be configured to command the charging to start according to the charge strategy automatically when auto-charge is enabled, or to start based upon a user input to the at least one user interface when the auto-charge is not enabled.

The telematics system may be configured to monitor the weather forecast data for updates once charging the vehicle starts.

The telematics system may be configured to connect the vehicle to a power station when the vehicle is charging, and the telematics system may be configured to automatically disconnect the vehicle from the power station when one of the updates to the weather forecast data includes a lightning strike within a predetermined distance of the vehicle.

The telematics system may be configured to automatically alert a user, via the at least one user interface, when the lightning strike is within the predetermined distance of the vehicle.

The telematics system may be configured to monitor the weather forecast data after the lightning strike and may automatically reconnect the vehicle to the power station after a predetermined time has elapsed without a subsequent lightning strike.

The at least one user interface may include an HMI within the vehicle and/or a mobile application installed on a personal user device, for example but not limited to, a smart phone or tablet.

Therefore, by predictively charging a vehicle including a RESS to a maximum possible charge prior to a potential power disruption based on a predicted weather event, the electric power stored within the vehicle may be utilized to power infrastructure, for example but not limited to, a furnace to heat a home, for a maximum amount of time during a power disruption or outage.

Further, predictively charging the vehicle may include automatically disconnecting the vehicle from a power station or source when a lightning strike is detected within a predetermined distance of the charging vehicle, minimizing the effects of a potential power surge to the vehicle.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure which, taken together with the description, serve to explain the principles of the disclosure.

FIG. 1 is a schematic illustration of a vehicle including a rechargeable energy storage system (RESS), and a telematics system according to the present disclosure.

FIG. 2 is a main flow chart illustrating a method of predictively charging a vehicle including a RESS according to the present disclosure.

FIG. 3 is a sub-flow chart, indicated in FIG. 2, illustrating generating a power status report.

The appended drawings are not necessarily to scale and may present a somewhat simplified representation of various preferred features of the present disclosure as disclosed herein, including, for example, specific dimensions, orientations, locations, and shapes. Details adjacent to such features will be determined in part by the particular intended application and use environment.

### DETAILED DESCRIPTION

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including.” “containing.” “comprising.” “having.” and the like shall mean “including without limitation.” Moreover, words of approximation such as “about,” “almost.” “substantially.” “generally,” “approximately.” etc., may be used herein in the sense of “at, near, or nearly at.” or “within 0-5% of,” or “within acceptable manufacturing tolerances,” or logical combinations thereof.

Referring now to the drawings, wherein like numerals indicate like parts in several views, a method of predictively charging a vehicle including a rechargeable energy storage system (RESS), and a predictively charging vehicle including a RESS, are shown and described herein.

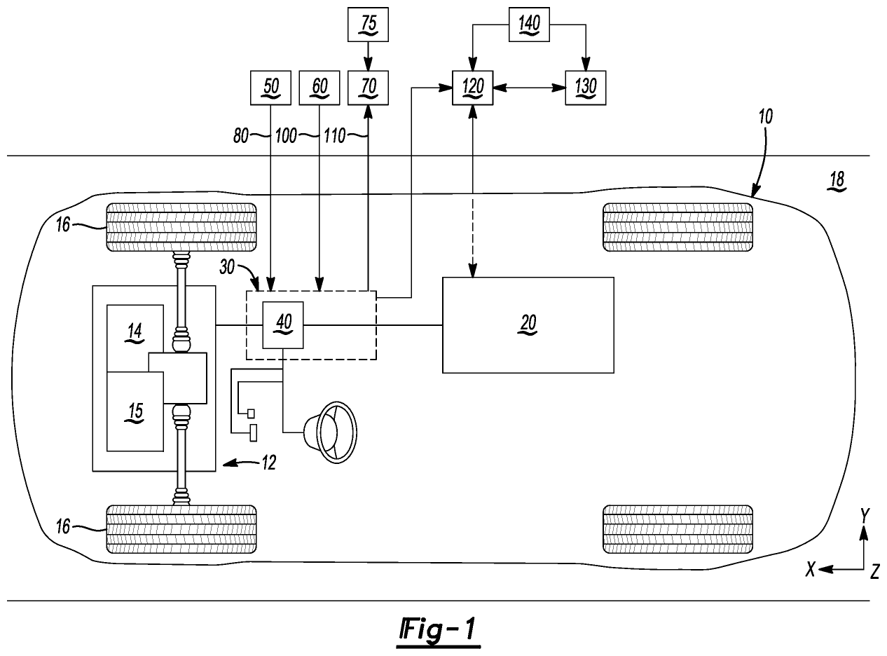

As illustrated in FIG. 1, a vehicle 10 includes a powertrain 12. The vehicle 10 may include, but is not limited to, a commercial vehicle, an industrial vehicle, a passenger vehicle, an aircraft, a watercraft, a train or the like.

The powertrain 12 includes a power-source 14 configured to generate a power-source torque T (not shown) for propulsion of the vehicle 10 via driven wheels 16 relative to a road surface 18. The power-source 14 is depicted as an electric motor-generator.

As further illustrated in FIG. 1, the powertrain 12 may also include an additional power-source 15, such as an internal combustion engine. The power-sources 14 and 15 may act in concert to power the vehicle 10.

The vehicle 10 includes a rechargeable energy storage system (RESS) 20 and a telematics system 30.

The RESS 20 is configured to generate and store electrical energy through heat-producing electro-chemical reactions for supplying the electrical energy to power the vehicle 10 during use and/or to power a structure, for example, but not limited to a house, during a power disruption or outage.

The telematics system 30 includes a telematics module 40 disposed in the vehicle 10 and at least one user interface 70. The telematics module 40 is in communication with at least one external data source 50, a utility data source 60, the at least one user interface 70, and the vehicle 10. The telematics module 40 is programmable and may include a central processing unit (CPU) that regulates various functions of the vehicle 10 and/or the RESS 20.

In either of the above configurations, the telematics module 40 includes a processor and tangible, non-transitory memory, which includes instructions for operation of vehicle 10 and the RESS 20 programmed therein. The memory may be an appropriate recordable medium that participates in providing computer-readable data or process instructions. Such a recordable medium may take many forms, including, but not limited to, non-volatile media and volatile media.

Non-volatile media for the telematics module 40 may include, for example, optical or magnetic disks and other persistent memory. Volatile media may include, for example, dynamic random-access memory (DRAM), which may constitute a main memory. Such instructions may be transmitted by one or more transmission medium, including coaxial cables, copper wire and fiber optics, including the wires that comprise a system bus coupled to a processor of a computer, or via a wireless connection.

Memory of the telematics module 40 may also include a flexible disk, hard disk, magnetic tape, another magnetic medium, a CD-ROM, DVD, another optical medium, etc. The telematics module 40 may be configured or equipped with other required computer hardware, such as a high-speed clock, requisite Analog-to-Digital (A/D) and/or Digital-to-Analog (D/A) circuitry, input/output circuitry and devices (I/O), as well as appropriate signal conditioning and/or buffer circuitry. Algorithms required by the telematics module 40 or accessible thereby, including, but not limited to predictive algorithms, may be stored in the memory and automatically executed to provide the required functionality of the vehicle 10, the RESS 20, and the telematics system 30.

The telematics system 30 is configured to receive weather forecast data 80 from the at least one external data source 50, monitor the weather forecast data 80 for a predicted weather event, and compare the predicted weather event to historical weather events during which power disruptions occurred as indicated by historical utility data corresponding to the historical weather events.

The predicted weather event may include, for example not limited to, a severe weather watch, a wind advisory, a lightning strike, an ice storm, a heat wave, or other weather phenomena that may include a power disruption.

The telematics system 30 is configured to receive household power consumption data 100 from the utility data source 60 and analyze household power consumption based on the household power consumption data 100 from the utility data source 60.

The telematics system 30 is configured to determine whether the predicted weather event is indicative of a potential power disruption based upon the comparison of the predicted weather event to the historical weather events during which power disruptions occurred as indicated by the historical utility data corresponding to the historical weather events and generate a power status report 110.

The power status report 110 is generated based upon determining that the predicted weather event is indicative of the potential power disruption.

Generating the power status report 110 via the telematics system 30 includes analyzing amount of energy stored in the vehicle 10, analyzing historical household power consumption based on household power consumption data 100 from the utility data source 60, analyzing predicted conditions of the predicted weather events and analyzing costs to charge the vehicle 10.

The telematics system 30 is configured to send the power status report 110 to the at least one user interface 70 and charge of the vehicle 10 based on the power status report 110 in preparation for the potential power disruption indicated by the predicted weather event.

Generating the power status report 110 includes generating a charge strategy to charge the vehicle 10 to a maximum charge possible before the potential power disruption while minimizing charging costs. The charge strategy may be based on a predictive algorithm stored in the telematics module 40.

The telematics system 30 is configured to command the charging of the vehicle 10 to start according to the charge strategy 110 automatically when auto-charge is enabled, and/or to start based upon a user input 75 to the at least one user interface 70, according to the charge strategy 110 when the auto-charge is not enabled.

The telematics system 30 is configured to monitor the weather forecast data 80 for updates once charging the vehicle 10 starts.

The telematics system 30 is configured to connect the vehicle 10 is to a power station 120 when charging of the vehicle 10 is commanded to start, and automatically disconnect the vehicle 10 from the power station 120 when one of the updates to the weather forecast data 80 includes a lightning strike within a predetermined distance of the vehicle 10.

The power station 120 and the household 130 are configured to receive power from an external power source 140, for example but not limited to, a utility provider, e.g., an electricity provider.

When the vehicle 10 is connected to the power station 120, the power station 120 is operable to provide power from the power station 120 to charge the vehicle 10, and/or provide power stored in the vehicle 10 to power a household 130.

When the vehicle 10 is disconnected from the power station 120, the power station 120 is no longer operable to provide power from the power station 120 to charge the vehicle 10. However, the vehicle 10 is operable to provide power stored in the vehicle 10 to power the household 130 when the vehicle 10 is disconnected from the power station 120.

The telematics system 30 is configured to automatically alert a user (not shown), via the at least one user interface 70, when the lightning strike is within the predetermined distance of the vehicle 10.

The telematics system 30 is configured to monitor the weather forecast data 80 after the lightning strike, to automatically reconnect the vehicle 10 to the power station 120 after a predetermined time has elapsed without a subsequent lightning strike, and to automatically command the charging of the vehicle 10 to start when the vehicle 10 is not charged to full capacity.

The at least one user interface 70 may include an HMI within the vehicle 10 and/or a mobile application installed on a personal user device, for example but not limited to, a smart phone or tablet.

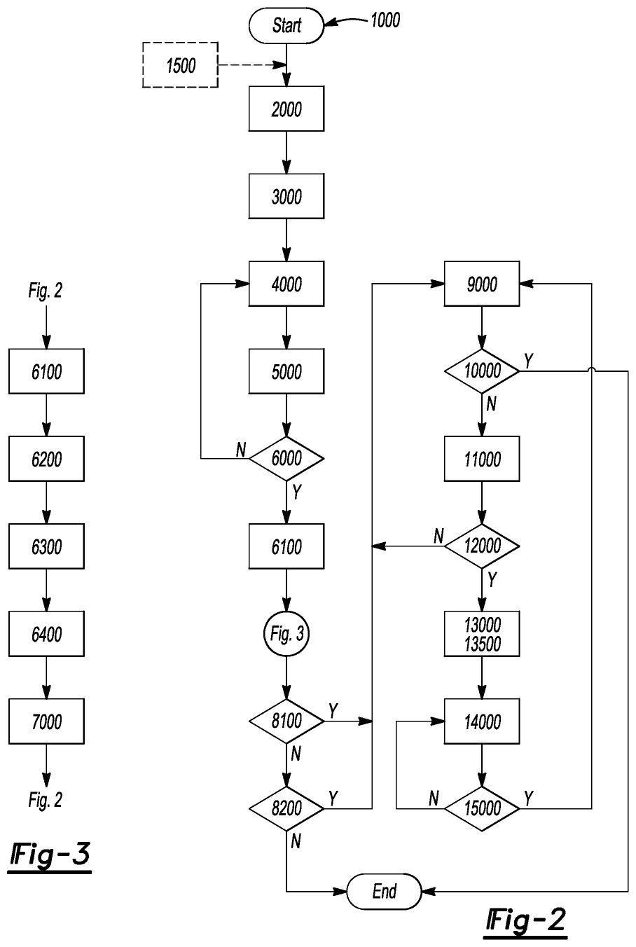

As illustrated in FIG. 2 with continued reference to FIG. 1, a method 1000 of predictively charging a vehicle 10 including a rechargeable energy storage system (RESS) 20 includes providing 2000 a telematics system 30 including a telematics module 40, at least one external data source 50, a utility data source 60, and at least one user interface 70. The telematics module 40 is disposed in a vehicle 10. The telematics module 40 is in communication with the at least one external data source 50, the utility data source 60, the at least one user interface 70, and the vehicle 10.

The method 1000 further includes: receiving 3000 weather forecast data 80 from the at least one external data source 50 via the telematics system 30; monitoring 4000 the weather forecast data 80 for a predicted weather event via the telematics system 30; comparing 5000 the predicted weather event to historical weather events during which power disruptions occurred as indicated by historical utility data corresponding to the historical weather events; determining 6000 whether the predicted weather event is indicative of a potential power disruption based upon the comparison; generating 7000 a power status report 110 based upon a determination that the predicted weather event may be indicative of the potential power disruption; sending 8000 the power status report 110 to the at least one user interface 70; and commanding 9000 a charging of the vehicle 10 based on the power status report 110 in preparation for the potential power disruption indicated by the predicted weather event.

Referring to FIG. 3 with continued reference to FIG. 1 and FIG. 2, generating 7000 the power status report 110 via the telematics system 30 includes: analyzing 6100 an amount of energy stored in the vehicle 10; analyzing 6200 a household power consumption based on household power consumption data 100 from the utility data source 60; analyzing 6300 predicted conditions of the predicted weather events; and analyzing 6400 costs to charge the vehicle 10.

Generating 7000 the power status report 110 includes generating a charge strategy to charge the vehicle 10 to a maximum charge possible before the potential power disruption while minimizing charging costs. The charge strategy is based on a predictive algorithm stored in the telematics module 40.

While the charge strategy is discussed as being included in the power status report 110, it should be appreciated that the power status report 110 may also include, but is not limited to, a type of potential power impact, a percentage charge of the vehicle 10, estimated duration of time that a current vehicle charge can support a household 130, estimated time until potential power loss, power draw of household items with respect to current power stored in the vehicle 10, suggestions as to which individual household items to turn off to increase supply time based on a current power stored in the vehicle 10.

Commanding 9000 the charging of the vehicle 10 according to the charge strategy to start automatically when an auto-charge is enabled 8100 or start based upon a user input 75 to the at least one user interface 70 when the auto-charge is not enabled 8200, until the vehicle 10 is fully charged 10000 or to a maximum possible charge prior to a potential power disruption based on a predicted weather event.

If the vehicle 10 is not fully charged, the telematics system 30 monitors 11000 the weather forecast data 80 for updates while the vehicle 10 is charging.

The telematics system is configured to connect the vehicle 10 to a power station 120 when the vehicle 10 is charging, and automatically disconnect 13000 the vehicle 10 from the power station 120 when a lightning strike is detected 12000 within a predetermined distance of the charging vehicle 10, i.e., one of the updates to the weather forecast data 80 includes a lightning strike within a predetermined distance of the charging vehicle 10.

The telematics system 30 is configured to monitor 14000 the weather forecast data 80 after the lightning strike and command 9000 the charging of the vehicle 10 to start after a predetermined time has elapsed without a subsequent lightning strike 15000.

The telematics system 30 is configured to automatically alert a user 13500, via the at least one user interface 70 when the lightning strike is detected within the predetermined distance of the vehicle 10.

Commanding 9000 the charging of the vehicle 10 based upon the power status report includes sending 8000 the power status report 110 to the at least one user interface 70.

The at least one user interface 70 may include an HMI within the vehicle 10 and/or a mobile application installed on a personal user device, for example but not limited to, a smart phone or tablet.

According to another aspect of the present disclosure, the method 1000 may include: providing 1500 a power station 120 that is connectable to the vehicle 10 including the RESS 20; commanding 9000 a charging of the vehicle 10 based on the power status report 110 in preparation for the potential power disruption indicated by the predicted weather event when the vehicle 10 is connected to the power station 120; and automatically disconnecting 13000 the vehicle 10 from the power station 120 when an update to the weather forecast data includes a lightning strike within a predetermined distance from the vehicle 10.

The power status report 110 includes a charge strategy to charge the vehicle 10 to a maximum charge possible before the potential power disruption while minimizing charging costs. The charge strategy is based on a predictive algorithm stored in the telematics module 40.

While the charge strategy is discussed as being included in the power status report 110, it should be appreciated that the power status report 110 may also include, but is not limited to, a type of potential power impact, a percentage charge of the vehicle 10, estimated duration of time that a current vehicle charge can support a household 130, estimated time until potential power loss, power draw of household items with respect to current power stored in the vehicle 10, suggestions as to which individual household items to turn off to increase supply time based on a current power stored in the vehicle 10.

Commanding 9000 the charging of the vehicle 10 according to the charge strategy starts automatically when an auto-charge is enabled 8100 or starts based upon a user input 75 to the at least one user interface 70 when the auto-charge is not enabled 8200, until the vehicle 10 is fully charged 10000, or to a maximum possible charge prior to a potential power disruption based on a predicted weather event.

Therefore, by predictively charging a vehicle including a rechargeable energy storage system (RESS), to a maximum possible charge prior to a potential power disruption based on a predicted weather event. The electric power stored within the vehicle may be utilized to power infrastructure, for example but not limited to, a furnace to heat a home, for a maximum amount of time during a power disruption or outage. Additionally, predictively charging a vehicle allows the vehicle to be automatically disconnected from a power station or source when a lightning strike is detected within a predetermined distance of the charging vehicle, minimizing effects of a potential power surge to the vehicle.

These and other attendant benefits of the present disclosure will be appreciated by those skilled in the art in view of the foregoing disclosure.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A method of predictively charging a vehicle including a rechargeable energy storage system (RESS), the method comprising:
providing a telematics system including a telematics module, at least one external data source, a utility data source, and at least one user interface, wherein the telematics module is disposed in a vehicle and the telematics module is in communication with the at least one external data source, the utility data source, the at least one user interface, and the vehicle;
receiving weather forecast data from the at least one external data source via the telematics system;
monitoring the weather forecast data for a predicted weather event via the telematics system;
comparing the predicted weather event to historical weather events during which power disruptions occurred as indicated by historical utility data corresponding to the historical weather events;
determining whether the predicted weather event is indicative of a potential power disruption based upon the comparison;
generating a power status report via the telematics system, wherein the power status report is generated based upon determining that the predicted weather event is indicative of the potential power disruption, and wherein generating the power status report includes:
analyzing an amount of energy stored in the vehicle;
analyzing a household power consumption based on household power consumption data from the utility data source;
analyzing predicted conditions of the predicted weather event; and
analyzing costs to charge the vehicle; and
sending the power status report to the at least one user interface; and
commanding a charging of the vehicle based on the power status report in preparation for the potential power disruption indicated by the predicted weather event.

2. The method as recited in claim 1, wherein generating the power status report includes generating a charge strategy to charge the vehicle to a maximum charge possible before the potential power disruption while minimizing charging costs, wherein the charge strategy is based on a predictive algorithm.

3. The method as recited in claim 2, wherein charging of the vehicle according to the charge strategy starts automatically when an auto-charge is enabled, and/or starts based upon a user input to the at least one user interface when the auto-charge is not enabled.

4. The method as recited in claim 3, wherein monitoring the weather forecast data for updates occurs when charging the vehicle starts.

5. The method as recited in claim 4, further comprising commanding a connecting of the vehicle to a power station when the vehicle is charging, and commanding an automatic disconnecting of the vehicle from the power station when one of the updates to the weather forecast data includes a lightning strike within a predetermined distance of the vehicle.

6. The method as recited in claim 5, further comprising monitoring the weather forecast data after the lightning strike; and automatically reconnecting the vehicle to the power station after a predetermined time has elapsed without a subsequent lightning strike.

7. The method as recited in claim 5, further comprising automatically alerting a user, via the at least one user interface, when the lightning strike is within the predetermined distance of the vehicle.

8. The method as recited in claim 1, wherein charging the vehicle based upon the power status report includes sending the power status report to the at least one user interface.

9. The method as recited in claim 1, wherein the at least one user interface includes an HMI in the vehicle and/or a mobile application.

10. A method of predictively charging a vehicle including a rechargeable energy storage system (RESS), the method comprising:
providing a power station that is connectable to a vehicle including a RESS;
providing a telematics system including a telematics module, at least one external data source, a utility data source, and at least one user interface, wherein the telematics module is disposed in the vehicle, and the telematics module is in communication with the at least one external data source, the utility data source, the at least one user interface, and the vehicle;
receiving weather forecast data from the at least one external data source via the telematics system;
monitoring the weather forecast data for a predicted weather event via the telematics system;
comparing the predicted weather event to historical weather events during which power disruptions occurred as indicated by historical utility data corresponding to the historical weather events;
determining whether the predicted weather event is indicative of a potential power disruption based upon the comparison;
generating a power status report via the telematics system, wherein the power status report is generated based upon determining that the predicted weather event is indicative of the potential power disruption, and wherein generating the power status report includes:
analyzing amount of energy stored in the vehicle;
analyzing historical household power consumption based on historical household power consumption data from the utility data source;
analyzing predicted conditions of the predicted weather event; and
sending the power status report to the at least one user interface; and
commanding a charging of the vehicle based on the power status report in preparation for the potential power disruption indicated by the predicted weather event when the vehicle is connected to the power station; and
commanding a disconnecting of the vehicle from the power station when an update to the weather forecast data includes a lightning strike within a predetermined distance from the vehicle.

11. The method as recited in claim 10, wherein generating the power status report includes generating a charge strategy to charge the vehicle to a maximum charge possible before the potential power disruption, wherein the charge strategy is based on a predictive algorithm.

12. The method as recited in claim 11, wherein charging of the vehicle according to the charge strategy starts automatically when an auto-charge is enabled, and/or starts based upon a user input to the at least one user interface when the auto-charge is not enabled.

13. A telematics system for predictively charging of a vehicle including a rechargeable energy storage system (RESS), the telematics system comprising:
a telematics module disposed in the vehicle;
at least one user interface, wherein the telematics module is in communication with at least one external data source, a utility data source, the at least one user interface, and the vehicle; and
wherein the telematics system is configured to:
receive weather forecast data from the at least one external data source;
monitor the weather forecast data for a predicted weather event;
compare the predicted weather event to historical weather events during which power disruptions occurred as indicated by historical utility data corresponding to the historical weather events;
determine whether the predicted weather event is indicative of a potential power disruption based upon the comparison;
generate a power status report, wherein the power status report is generated based upon determining that the predicted weather event is indicative of the potential power disruption, and wherein generating the power status report includes:
analyzing amount of energy stored in the vehicle;
analyzing historical household power consumption based on historical household power consumption data from the utility data source;
analyzing predicted conditions of the predicted weather event; and
analyzing costs to charge the vehicle; and
send the power status report to the at least one user interface; and
command a charging of the vehicle based on the power status report in preparation for the potential power disruption indicated by the predicted weather event.

14. The telematics system as recited in claim 13, wherein the power status report includes a charge strategy to charge the vehicle to a maximum charge possible before the potential power disruption while minimizing charging costs, wherein the charge strategy is based on a predictive algorithm.

15. The telematics system as recited in claim 14, wherein the telematics system is configured to command the charging to start according to the charge strategy automatically when auto-charge is enabled, and/or to start based upon a user input to the at least one user interface when the auto-charge is not enabled.

16. The telematics system as recited in claim 15, wherein the telematics system is configured to monitor the weather forecast data for updates once charging the vehicle starts.

17. The telematics system as recited in claim 16, wherein the telematics system is configured to connect the vehicle to a power station when charging the vehicle is commanded to start, and automatically disconnect the vehicle from the power station when one of the updates to the weather forecast data includes a lightning strike within a predetermined distance of the vehicle.

18. The telematics system as recited in claim 17, wherein the telematics system is configured to automatically alert a user, via the at least one user interface, when the lightning strike is within the predetermined distance of the vehicle.

19. The telematics system as recited in claim 17, wherein the telematics system is configured to monitor the weather forecast data after the lightning strike, and to automatically reconnect the vehicle to the power station after a predetermined time has elapsed without a subsequent lightning strike.

20. The telematics system as recited in claim 13, wherein the at least one user interface includes an HMI within the vehicle and/or a mobile application.
